(19) United States
(12) Patent Application Publication
(10) Pub. No.: US 2011/0085773 A1
(43) Pub. Date: Apr. 14, 2011

(54) OPTICAL WAVEGUIDE AND METHOD OF FORMING THE SAME

(75) Inventor: Min-su KIM, Daejeon (KR)

(73) Assignee: ELECTRONICS AND TELECOMMUNICATIONS RESEARCH INSTITUTE, Daejeon (KR)

(21) Appl. No.: 12/873,415

(22) Filed: Sep. 1, 2010

(30) Foreign Application Priority Data
Oct. 13, 2009 (KR) 10-2009-0097307
Apr. 2, 2010 (KR) 10-2010-0030209

(51) Int. Cl. G02B 6/10

(52) U.S. Cl. 385/131; 427/163.2

(57) ABSTRACT

Provided is an optical waveguide and a method of forming the same. The optical waveguide comprises inductive thin films and a waveguide thin film. The inductive thin films are disposed to be separated from each other. The waveguide thin film fills a gap which separates the inductive thin films, and covers at least one portion of the inductive thin films. A refractive index of the waveguide thin film is greater than refractive indexes of the inductive thin films.

### CROSS-REFERENCE TO RELATED APPLICATIONS

This U.S. non-provisional patent application claims priority under 35 U.S.C. §119 of Korean Patent Application Nos. 10-2009-0097307, filed on Oct. 13, 2009, and 10-2010-0030209, filed on Apr. 2, 2010, the entire contents of which are hereby incorporated by reference.

### BACKGROUND OF THE INVENTION

The present invention disclosed herein relates to an optical transmission device and a method of forming the same, and more particularly, to an optical waveguide and a method of forming the same.

Long distance optical signal transmission using an optical fiber is recognized as the typical type of optical communication. However, since an optical fiber does not have a great advantage in a short distance optical signal transmission range, optical waveguide devices using various materials are being used in a wide application domain, based on a Planar Lightwave Circuit (PLC) technology.

Recently, by applying an optical interconnection technology to a signal transmission line of several centimeters to tens meters, research and development are being actively made for solving limitations due to the existing electrical technology. However, the existing optical fiber technology and the PLC technology have problems of economic efficiency and usefulness in aspects of manufacture and treatment, there are limitations in providing an optical transmission line suitable for a wide application domain.

### SUMMARY OF THE INVENTION

The present invention provides an optical waveguide and a method of forming the same, which can be variously used.

Embodiments of the present invention provide an optical waveguide includes: inductive thin films disposed to be separated from each other; and a waveguide thin film filling a gap which separates the inductive thin films, and covering at least one portion of the inductive thin films, wherein a refractive index of the waveguide thin film is greater than refractive indexes of the inductive thin films.

In some embodiments, the waveguide thin film may cover upper and lower surfaces of the inductive thin films.

In other embodiments, light which is transferred to the waveguide thin film filling the gap may form a mode and be guided.

In still other embodiments, a width of the gap may be equal to or greater than one-fifth of a thickness of the waveguide thin film.

In even other embodiments, the inductive thin films may include: first inductive thin films covered by the waveguide thin film; and second inductive thin films covering a side of the waveguide thin film, wherein the second inductive thin films may be thicker than the first inductive thin films.

In yet other embodiments, the inductive thin films may include first, second and third inductive thin films disposed on the same plane, and the gap may further include: a first gap separating the first and second inductive thin films; and a second gap separating the second and third inductive thin films.

In further embodiments, a first lightwave component which is transferred along the first gap of the waveguide thin film and a second lightwave component which is transferred along the second gap may be combined to form one optical mode and be guided.

In still further embodiments, a first lightwave component which is transferred along the first gap of the waveguide thin film and a second lightwave component which is transferred along the second gap may be separated from each other to form respective optical modes.

In even further embodiments, the optical waveguide may further include: a first region including the first and third inductive thin films; and a second region including the first, second and third inductive thin films, wherein: the gap may further include a third gap separating the first and third inductive thin films in the first region, and the first and second gaps are disposed in the second region, and are formed to be split from the third gap.

In yet further embodiments, the third gap, the first gap and the second gap may have a Y-shaped connection structure therebetween.

In much further embodiments, the optical waveguide may further include: first and second regions including the first, second and third inductive thin films, wherein: a separated distance between the first and second gaps disposed in the first region may be shorter than a separated distance between the first and second gaps disposed in the second region.

In still much further embodiments, respective lightwave components which are transferred along the first and second gaps may be combined to form one optical mode and be guided in the first region, and the lightwave components may be divided into respective optical modes and be guided in the second region.

In even much further embodiments, the inductive thin films may include: first inductive thin films disposed on a first plane; and second inductive thin films disposed on a second plane above the first plane.

In yet much further embodiments, the gap may include: a first gap separating the first inductive thin films; and a second gap separating the second inductive thin films, wherein the first and second gaps may be disposed to be overlapped with each other.

In yet much further embodiments, the gap may include: a first gap separating the first inductive thin films; and a second gap separating the second inductive thin films, and the optical waveguide may further include: a first region where the first and second gaps are disposed to be overlapped with each other; and a second region where the first and second gaps are disposed to be separated from each other.

In yet much further embodiments, the optical waveguide may further include: an additional layer covering the waveguide thin film, and having a refractive index less than a refractive index of the waveguide thin film.

In yet much further embodiments, the optical waveguide may further include a basal layer covering the waveguide thin film.

In other embodiments of the present invention, a method of forming optical waveguide include: forming a first waveguide thin film; forming inductive thin films which are separated from each other on the first waveguide thin film; and forming a second waveguide thin film which fills a gap separating the inductive thin films and covers the inductive thin films, wherein the first waveguide thin film, the inductive thin films and the second waveguide thin film are formed in a continuous process.

In some embodiments, the continuous process may include a roll-to-roll process or a direct printing process.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a diagram schematically illustrating a conceptual view of an optical waveguide according to an embodiment of the present invention;

FIG. 2 is a perspective view for describing an optical waveguide according to a first embodiment of the present invention;

FIG. 3 is a cross-sectional view for describing an optical waveguide according to a first embodiment of the present invention;

FIG. 4 is a perspective view for describing an optical waveguide according to a second embodiment of the present invention;

FIG. 5 is a cross-sectional view for describing an optical waveguide according to a second embodiment of the present invention;

FIG. 6 is a perspective view for describing an optical waveguide according to a third embodiment of the present invention;

FIG. 7 is a cross-sectional view for describing an optical waveguide according to a third embodiment of the present invention;

FIG. 8 is a perspective view for describing an optical waveguide according to a fourth embodiment of the present invention;

FIG. 9 is a plan view for describing an optical waveguide according to a fourth embodiment of the present invention;

FIG. 10 is a perspective view for describing an optical waveguide according to a fifth embodiment of the present invention;

FIG. 11 is a plan view for describing an optical waveguide according to a fifth embodiment of the present invention;

FIG. 12 is a perspective view for describing an optical waveguide according to a sixth embodiment of the present invention;

FIG. 13 is a cross-sectional view for describing an optical waveguide according to a sixth embodiment of the present invention;

FIG. 14 is a perspective view for describing an optical waveguide according to a seventh embodiment of the present invention;

FIG. 15 is a plan view for describing an optical waveguide according to a seventh embodiment of the present invention;

FIG. 16 is a cross-sectional view for describing an optical waveguide according to an eighth embodiment of the present invention;

FIG. 17 is a cross-sectional view for describing an optical waveguide according to a ninth embodiment of the present invention;

FIGS. 18A to 18D are cross-sectional views for describing a method of forming optical waveguide according to an embodiment of the present invention; and

FIG. 19 are cross-sectional views for describing a method of forming optical waveguide based on a continuous process according to an embodiment of the present invention.

### DETAILED DESCRIPTION OF PREFERRED EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

In the specification, it will be understood that when one element is referred to as being ‘on’ another element, it can be directly on the other element, or intervening elements may also be present. In the figures, moreover, the dimensions of elements are exaggerated for clarity of illustration. Like reference numerals refer to like elements throughout.

Additionally, the embodiment in the detailed description will be described with sectional views as ideal exemplary views of the present invention. In the figures, the dimensions of layers and regions are exaggerated for clarity of illustration. Accordingly, shapes of the exemplary views may be modified according to manufacturing techniques and/or allowable errors. Therefore, the embodiments of the present invention are not limited to the specific shape illustrated in the exemplary views, but may include other shapes that may be created according to manufacturing processes. Areas exemplified in the drawings have general properties, and are used to illustrate a specific shape of a corresponding region. Thus, this should not be construed as limited to the scope of the present invention. It will be understood that although the terms first and second are used herein to describe various elements, these elements should not be limited by these terms. An embodiment described and exemplified herein includes a complementary embodiment thereof.

The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components.

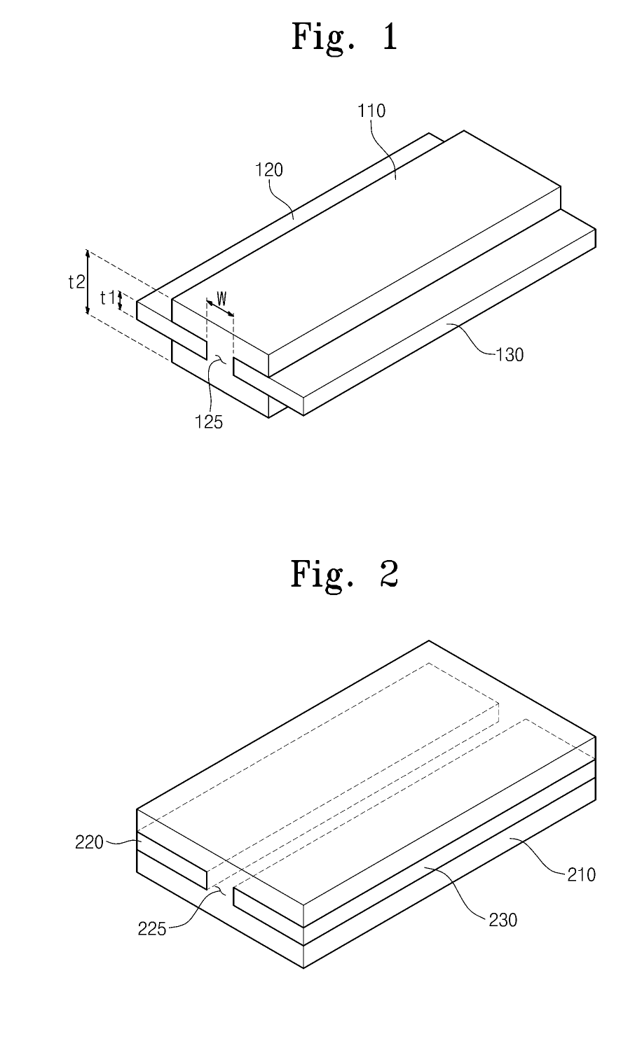

FIG. 1 is a diagram schematically illustrating a conceptual view of an optical waveguide according to an embodiment of the present invention.

Referring to FIG. 1, inductive thin films 120 and 130 are disposed to be separated from each other. Provided is a waveguide thin film 110 that fills a gap 125 for separating the inductive thin films 120 and 130 and covers at least one portion of the inductive thin films 120 and 130. The refractive index of the waveguide thin film 110 is greater than the refractive indexes of the inductive thin films 120 and 130. Light, which is transferred to the waveguide thin film 110 filling the gap 125, may form a mode and be guided along the gap 125.

The inductive thin films 120 and 130 and the waveguide thin film 110 may include inorganic materials such as silica, silicon or compound semiconductor. Alternatively, the inductive thin films 120 and 130 and the waveguide thin film 110 may include organic materials such as polymer or organic-inorganic composite materials. The inductive thin films 120 and 130 and the waveguide thin film 110 are formed of the same material or different materials. The respective inductive thin films 120 and 130 are formed of the same material or different materials. The inductive thin films 120 and 130 and the waveguide thin film 110 may have a multi-layered structure. In this case, the effective indexes of the inductive thin films 120 and 130 may be less than that of the waveguide thin film 110.

The thickness t1 of the inductive thin films 120 and 130, the width W of the gap 125 and the thickness t2 of the waveguide thin film 110 may be variously controlled according to the desired characteristic of an optical waveguide. The width W of the gap 125 may be equal to or greater than one-fifth of the thickness t2 of the waveguide thin film 110. In a single mode waveguide condition, the width W of the gap 125 may be equal to or greater than the thickness t2 of the waveguide thin film 110. When the thickness t2 of the waveguide thin film 110 is smaller than the width W of the gap 125, light which is transferred to the waveguide thin film 110 filling the gap 125 may be concentrated on the gap 125 and be guided. On the other hand, when the thickness t2 of the waveguide thin film 110 is greater than the width W of the gap 125, light which is transferred to the waveguide thin film 110 filling the gap 125 may not be concentrated on the gap 125 and may show characteristic in which it is spread toward a part of the waveguide thin film 110 covering the inductive thin films 120 and 130.

As the thickness t1 of the inductive thin films 120 and 130 is thicker and the width W of the gap 125 becomes broader, light which is transferred to the waveguide thin film 110 filling the gap 125 may be concentrated and guided. On the other hand, if the thickness t1 of the inductive thin films 120 and 130 is thin and the thickness t2 of the waveguide thin film 110 is relatively thick, light which is transferred to the waveguide thin film 110 filling the gap 125 may not be concentrated.

Accordingly, optical transfer characteristic may be controlled by combining the thickness t1 of the inductive thin films 120 and 130, the width W of the gap 125 and the thickness t2 of the waveguide thin film 110. As the width W of the gap 125 becomes broader, the thickness t1 of the inductive thin films 120 and 130 becomes thicker and the thickness t2 of the waveguide thin film 110 becomes thinner, an optical mode may be concentrated. By combining these conditions, a single-mode or multi-mode optical signal, or a plurality of optical signals may be transmitted.

For example, the thickness t1 of the inductive thin films 120 and 130 may be about 0.01 μm an to about 50 μm, and the width W of the gap 125 may be about 1 μm to about 200 μm. The thickness t2 of the waveguide thin film 110 may be about 2 μm to about 500 μm.

The optical waveguide according to an embodiment of the present invention may be used as a rigid optical waveguide or a flexible optical waveguide depending on requirement. When the optical waveguide is used as the flexible optical waveguide, at least the waveguide thin film 110 among the inductive thin films 120 and 130 and the waveguide thin film 110 may have good flexibility, and, at a portion where a severe bend occurs, the inductive thin films 120 and 130 and the waveguide thin film 110 may have high flexibility.

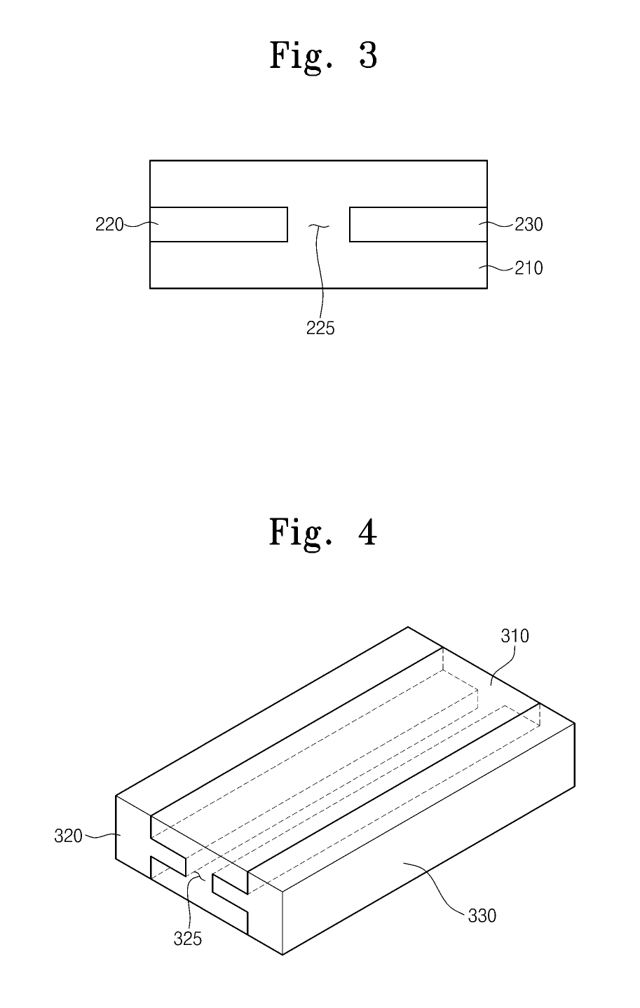

FIG. 2 is a perspective view for describing an optical waveguide according to a first embodiment of the present invention. FIG. 3 is a cross-sectional view for describing an optical waveguide according to a first embodiment of the present invention. A detailed description will be omitted on the substantially same technical feature as that of an embodiment of the present invention that has been described above with reference to FIG. 1.

Referring to FIGS. 2 and 3, inductive thin films 220 and 230 are disposed to be separated from each other. Provided is a waveguide thin film 210 that fills a gap 225 for separating the inductive thin films 220 and 230 and covers at least one portion of the inductive thin films 220 and 230. The refractive index of the waveguide thin film 210 is greater than the refractive indexes of the inductive thin films 220 and 230. Light, which is transferred to the waveguide thin film 210 filling the gap 225, may form a mode and be guided along the gap 225. The waveguide thin film 210 may cover all the upper and lower surfaces of the inductive thin films 220 and 230. When the waveguide thin film 210 is relatively thin, an optical signal may be guided along the gap 225 while forming a well-shaped mode and may not be spread toward a part of the waveguide thin film 210 covering the inductive thin films 220 and 230.

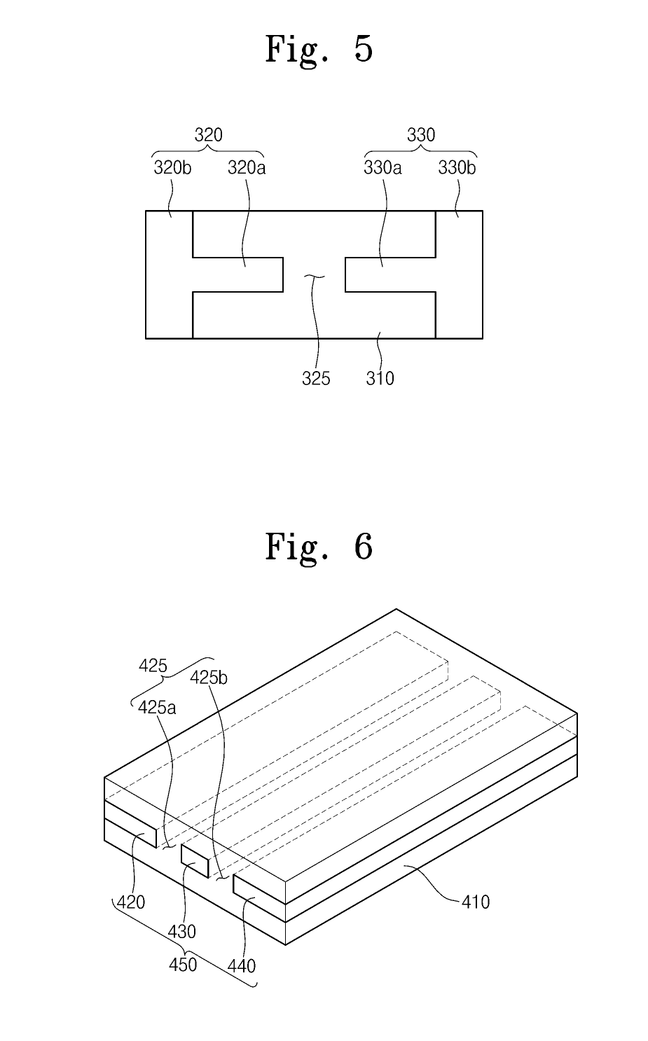

FIG. 4 is a perspective view for describing an optical waveguide according to a second embodiment of the present invention. FIG. 5 is a cross-sectional view for describing an optical waveguide according to a second embodiment of the present invention. A detailed description will be omitted on the substantially same technical feature as that of an embodiment of the present invention that has been described above with reference to FIG. 1.

Referring to FIGS. 4 and 5, inductive thin films 320 and 330 are disposed to be separated from each other. Provided is a waveguide thin film 310 that fills a gap 325 for separating the inductive thin films 320 and 330 and covers at least one portion of the inductive thin films 320 and 330. The refractive index of the waveguide thin film 310 is greater than the refractive indexes of the inductive thin films 320 and 330. Light, which is transferred to the waveguide thin film 310 filling the gap 325, may form a mode and be guided along the gap 325.

The inductive thin films 320 and 330 may include first inductive thin films 320a and 330a that are covered by the waveguide thin film 310, and second inductive thin films 320b and 330b that cover the side surface of the waveguide thin film 310. The second inductive thin films 320b and 330b may be thicker than the first inductive thin films 320a and 330a.

Comparing with the first embodiment of the present invention that has been described above, the optical waveguide according to the second embodiment of the present invention can reduce characteristic where light is excessively spread toward the part of the waveguide thin film 310 covering the first inductive thin films 320a and 330a by virtue of the second inductive thin films 320b and 330b.

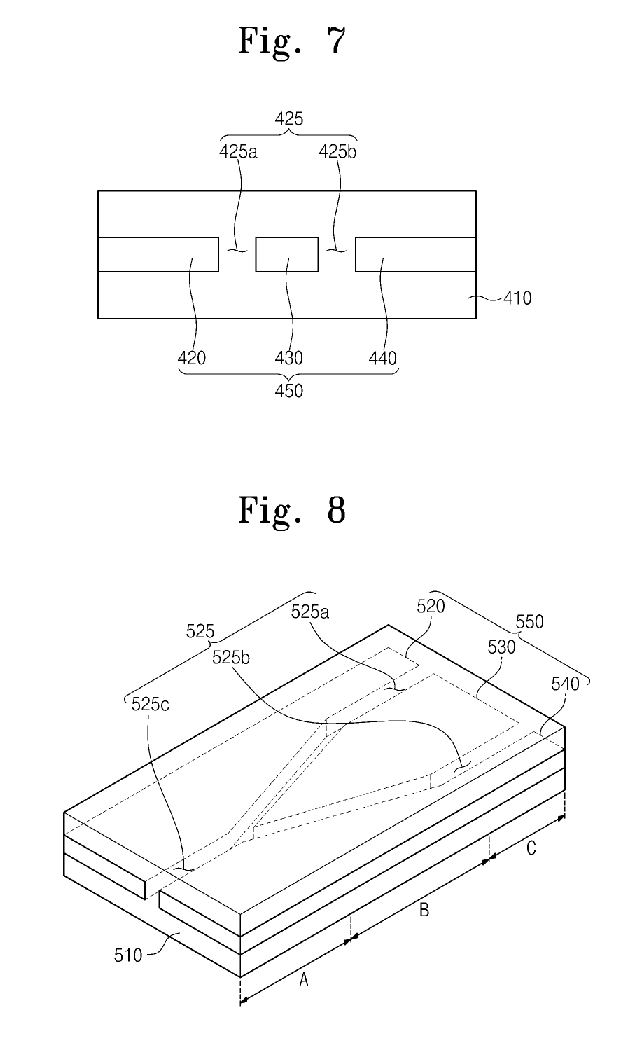

FIG. 6 is a perspective view for describing an optical waveguide according to a third embodiment of the present invention. FIG. 7 is a cross-sectional view for describing an optical waveguide according to a third embodiment of the present invention. A detailed description will be omitted on the substantially same technical feature as that of an embodiment of the present invention that has been described above with reference to FIG. 1.

Referring to FIGS. 6 and 7, inductive thin films 450 are disposed to be separated from each other. Provided is a waveguide thin film 410 that fills a gap 425 for separating the inductive thin films 450 and covers at least one portion of the inductive thin films 450. The refractive index of the waveguide thin film 410 is greater than the refractive indexes of the inductive thin films 450. Light, which is transferred to the waveguide thin film 410 filling the gap 425, may form a mode and be guided along the gap 425.

The inductive thin films 450 may include a first inductive thin film 420, a second inductive thin film 430 and a third inductive thin film 440 that are disposed on the same plane. The gap 425 may include a first gap 425a for separating the first and second inductive thin films 420 and 430, and a second gap 425b for separating the second and third inductive thin films 430 and 440. The waveguide thin film 410 may fill the first gap 425a for separating the first and second inductive thin films 420 and 430 and the second gap 425b for separating the second and third inductive thin films 430 and 440.

A first lightwave component that is transferred along the first gap 425a and a second lightwave component that is transferred along the second gap 425b may be combined to form one optical mode and be guided. This can be achieved by means of that a distance between the first and second gaps 425a and 425b is nearby kept by making the width of the second inductive thin film 430 narrow.

Alternatively, the first lightwave component that is transferred along the first gap 425a and the second lightwave component that is transferred along the second gap 425b may be separated from each other to form respective optical modes and be guided. This can be achieved by means of that a distance between the first and second gaps 425a and 425b is far kept by making the width of the second inductive thin film 430 broad.

According to another embodiment of the present invention, various types of optical signal transfer may be possible through the simple control and modification of the inductive thin films 450.

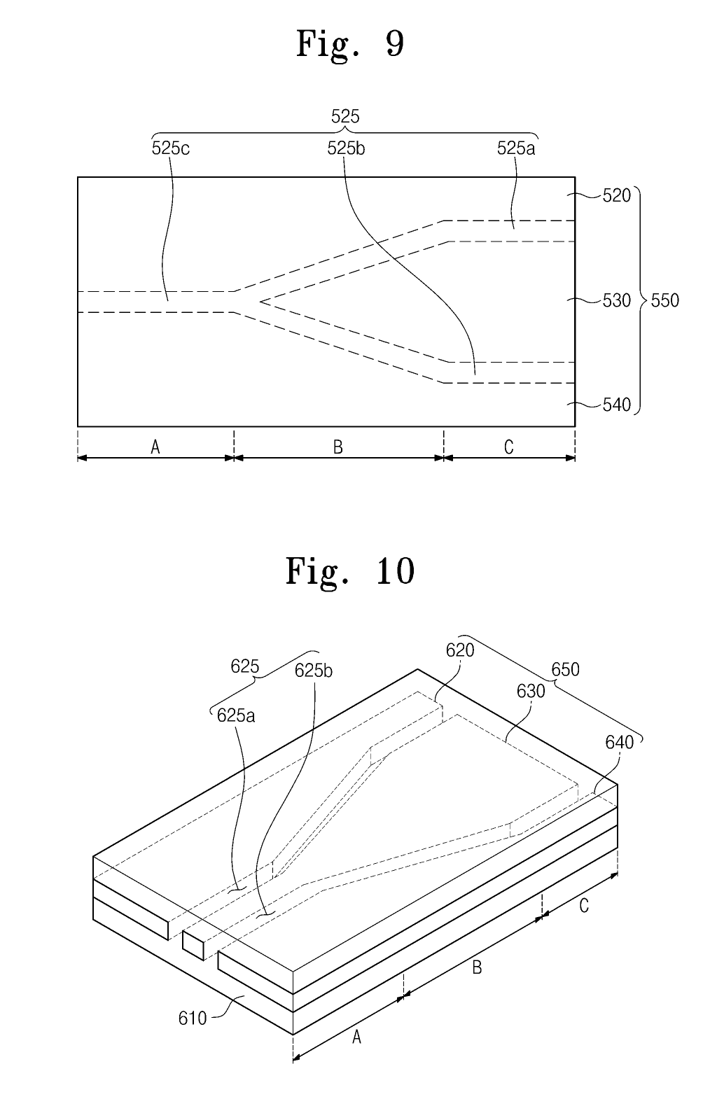

FIG. 8 is a perspective view for describing an optical waveguide according to a fourth embodiment of the present invention. FIG. 9 is a plan view for describing an optical waveguide according to a fourth embodiment of the present invention. A detailed description will be omitted on the substantially same technical feature as that of an embodiment of the present invention that has been described above with reference to FIG. 1.

Referring to FIGS. 8 and 9, inductive thin films 550 are disposed to be separated from each other. Provided is a waveguide thin film 510 that fills a gap 525 for separating the inductive thin films 550 and covers at least one portion of the inductive thin films 550. The refractive index of the waveguide thin film 510 is greater than the refractive indexes of the inductive thin films 550. Light, which is transferred to the waveguide thin film 510 filling the gap 525, may form a mode and be guided along the gap 525.

The inductive thin films 550 may include a first inductive thin film 520, a second inductive thin film 540 and a third inductive thin film 530 that are disposed on the same plane. The optical waveguide may include a first region A that includes the first and second inductive thin films 520 and 540, and a second region C that includes the first, second and third inductive thin films 520, 540 and 530. A transition region B may be disposed between the first and second regions A and C.

The gap 525 may include a first gap 525a for separating the first and third inductive thin films 520 and 530 and, a second gap 525b for separating the second and third inductive thin films 540 and 530 in the second region C, and a third gap 525c for separating the first and second inductive thin films 520 and 540 in the first region A.

The first and second gaps 525a and 525b may be formed to be split from the third gap 525c. The first and second gaps 525a and 525b may become split in the transition region B. The first, second and third gaps 525a to 525c may have a Y-shaped connection structure therebetween.

A first lightwave component that is transferred along the first gap 525a and a second lightwave component that is transferred along the second gap 525b may be separated from each other to form respective optical modes and be guided. This can be achieved by means of that a distance between the first and second gaps 525a and 525b is far kept by making the width of the third inductive thin film 530 broad sufficiently. An optical waveguide having this shape may be used as a Y-splitter. A means for controlling optical transfer characteristic may be included in the transition region B. In this case, the optical waveguide may be used as a kind of optical switch.

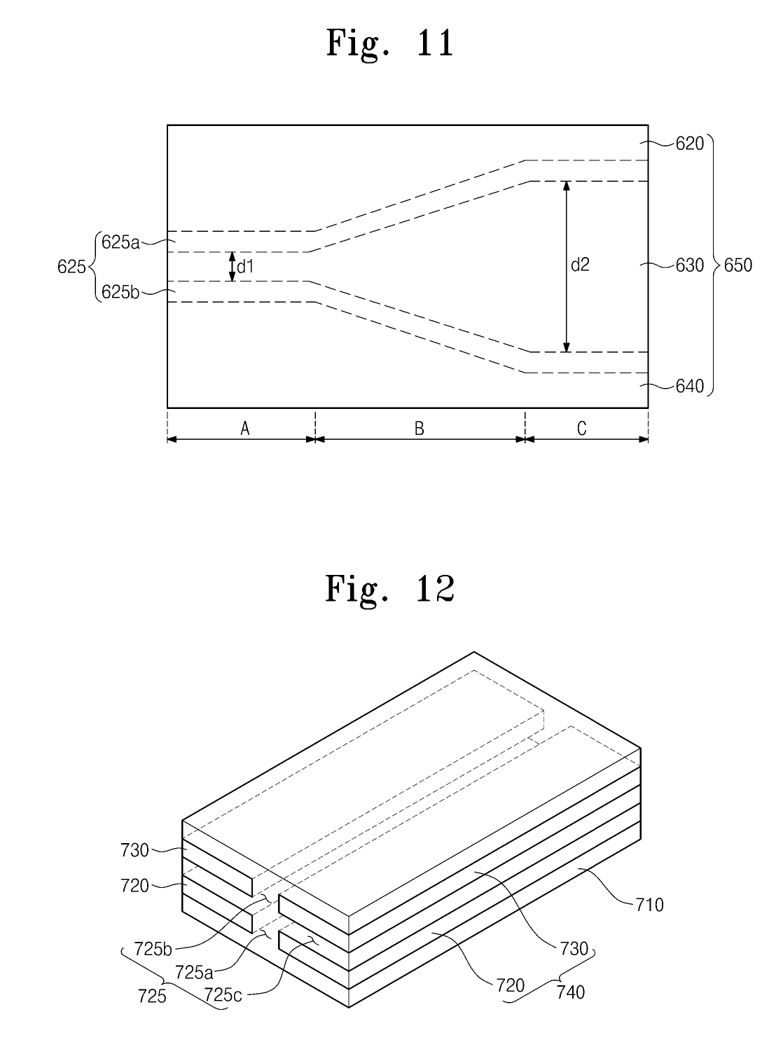

FIG. 10 is a perspective view for describing an optical waveguide according to a fifth embodiment of the present invention. FIG. 11 is a plan view for describing an optical waveguide according to a fifth embodiment of the present invention. A detailed description will be omitted on the substantially same technical feature as that of an embodiment of the present invention that has been described above with reference to FIG. 1.

Referring to FIGS. 10 and 11, inductive thin films 650 are disposed to be separated from each other. Provided is a waveguide thin film 610 that fills a gap 625 for separating the inductive thin films 650 and covers at least one portion of the inductive thin films 650. The refractive index of the waveguide thin film 610 is greater than the refractive indexes of the inductive thin films 650. Light, which is transferred to the waveguide thin film 610 filling the gap 625, may form a mode and be guided along the gap 625.

The inductive thin films 650 may include a first inductive thin film 620, a second inductive thin film 640 and a third inductive thin film 630 that are disposed on the same plane. The gap 625 may include a first gap 625a for separating the first and third inductive thin films 620 and 630, and a second gap 625b for separating the second and third inductive thin films 640 and 630.

The optical waveguide may include a first region A where a separated distance d1 between the first and second gaps 625a and 625b is relatively short, and a second region B where a separated distance d2 between the first and second gaps 625a and 625b is relatively long. A transition region B may be disposed between the first and second regions A and C.

A first lightwave component that is transferred along the first gap 625a and a second lightwave component that is transferred along the second gap 625b may be combined to form one optical mode in the first region A and be guided, and then they may be separated from each other to form respective optical modes and be guided in the second region C. This can be achieved by means of that a distance between the first and second gaps 625a and 625b is nearby kept in the first region A and is far kept in the second region B by controlling the width of the third inductive thin film 630.

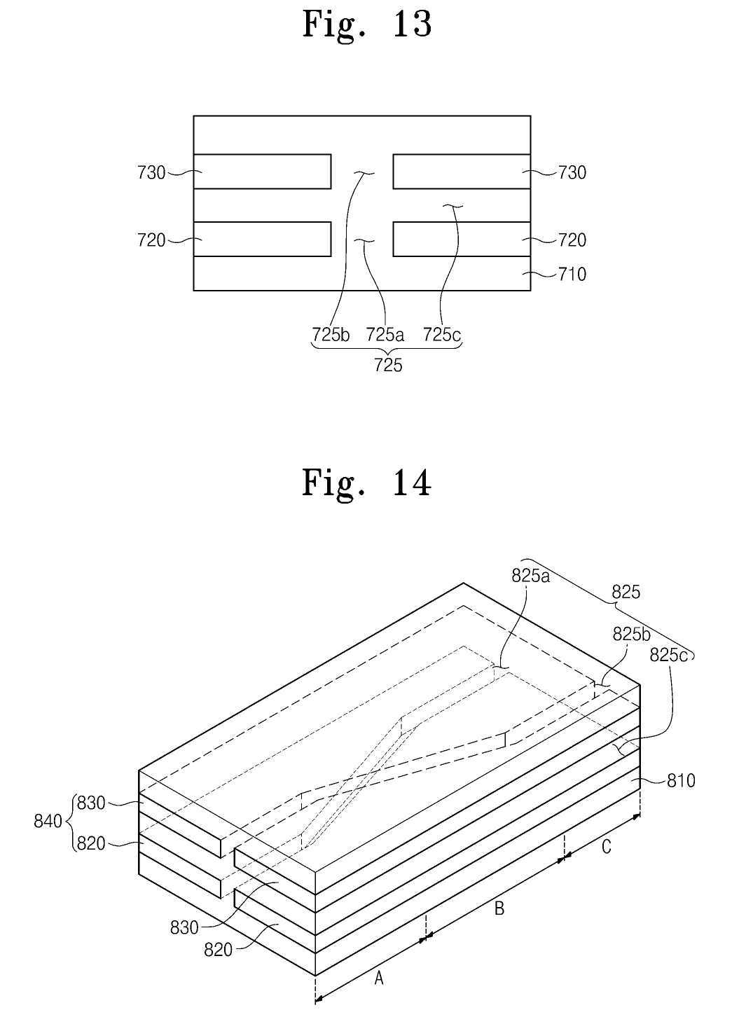

FIG. 12 is a perspective view for describing an optical waveguide according to a sixth embodiment of the present invention. FIG. 13 is a cross-sectional view for describing an optical waveguide according to a sixth embodiment of the present invention. A detailed description will be omitted on the substantially same technical feature as that of an embodiment of the present invention that has been described above with reference to FIG. 1.

Referring to FIGS. 12 and 13, inductive thin films 740 are disposed to be separated from each other. Provided is a waveguide thin film 710 that fills a gap 725 for separating the inductive thin films 740 and covers at least one portion of the inductive thin films 740. The refractive index of the waveguide thin film 710 is greater than the refractive indexes of the inductive thin films 740. Light, which is transferred to the waveguide thin film 710 filling the gap 725, may form a mode and be guided along the gap 725.

The inductive thin films 740 may include first inductive thin films 720 that are disposed on a first plane, and second inductive thin films 730 that are disposed on a second plane above the first plane. The gap 725 may include a first gap 725a for separating the first inductive thin films 720, and a second gap 725b for separating the second inductive thin films 730. Moreover, the gap 725 may further include a third gap 725c for separating the first and second inductive thin films 720 and 730 up and down. The first and second gaps 725a and 725b may be disposed to be substantially overlapped. That is, the first and second gaps 725a and 725b may be overlapped in the vertical direction and be extended in the same direction.

Respective lightwave components that are transferred along the first and second gaps 725a and 725b may be combined to form one optical mode and be guided, or they may form respective optical modes separated and be guided. This may be controlled by maintaining the third gap 725c narrowly or broadly.

Depending on a formation technology, an allowable error or specific technical requirement, even when the first and second gaps 725a and 725b deviate from the overlap of the vertical direction in a range within several times (for example, two to three times) the width of the gaps 725, the respective lightwave components may be coupled to form one optical mode or may form respective optical modes with interaction therebetween because a distance between the respective modes is close. These cases can be understood as examples of substantial overlap, and thus it is included in the spirits and scopes of embodiments of the present invention.

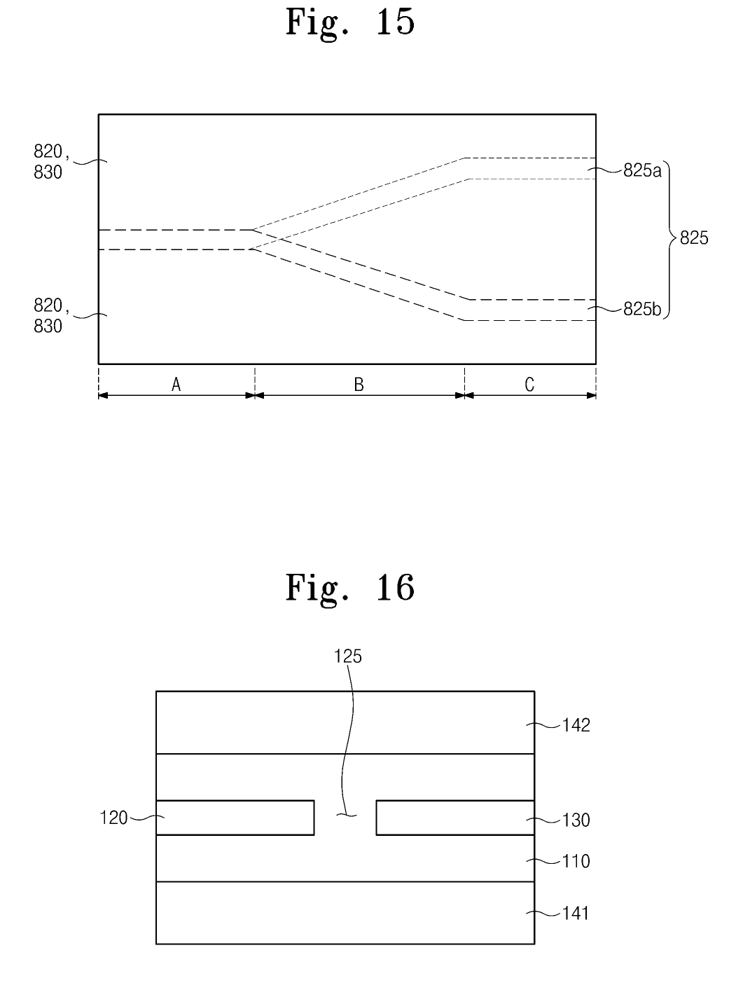

FIG. 14 is a perspective view for describing an optical waveguide according to a seventh embodiment of the present invention. FIG. 15 is a plan view for describing an optical waveguide according to a seventh embodiment of the present invention. A detailed description will be omitted on the substantially same technical feature as that of an embodiment of the present invention that has been described above with reference to FIG. 1.

Referring to FIGS. 14 and 15, inductive thin films 840 are disposed to be separated from each other. Provided is a waveguide thin film 810 that fills a gap 825 for separating the inductive thin films 840 and covers at least one portion of the inductive thin films 840. The refractive index of the waveguide thin film 810 is greater than the refractive indexes of the inductive thin films 840. Light, which is transferred to the waveguide thin film 810 filling the gap 825, may form a mode and be guided along the gap 825.

The inductive thin films 840 may include first inductive thin films 820 that are disposed on a first plane, and second inductive thin films 830 that are disposed on a second plane above the first plane. The gap 825 may include a first gap 825a for separating the first inductive thin films 820, and a second gap 825b for separating the second inductive thin films 830. Moreover, the gap 825 may further include a third gap 825c for separating the first and second inductive thin films 820 and 830 up and down. The optical waveguide may include a first region A where the first and second gaps 825a and 825b are disposed to be substantially overlapped, and a second region C where the first and second gaps 825a and 825b are disposed to be separated from each other. A transition region B may be disposed between the first region A and the second region C. The first and second gaps 825a and 825b deviate and become separated from each other in the transition region B, and then they may be separated in a horizontal distance in the second region C.

Respective lightwave components that is transferred along the first gap 825a and the second gap 825b may be combined to form one optical mode in the first region A and be guided, and then they may be separated to respective optical modes and be guided separately along the first gap 825a and the second gap 825b in the second region C.

FIG. 16 is a cross-sectional view for describing an optical waveguide according to an eighth of the present invention. A detailed description will be omitted on the substantially same technical feature as that of an embodiment of the present invention that has been described above with reference to FIG. 1.

Referring to FIG. 16, inductive thin films 120 and 130 are disposed to be separated from each other. Provided is a waveguide thin film 110 that fills a gap 125 for separating the inductive thin films 120 and 130 and covers at least one portion of the inductive thin films 120 and 130. The refractive index of the waveguide thin film 110 is greater than the refractive indexes of the inductive thin films 120 and 130. Light, which is transferred to the waveguide thin film 110 filling the gap 125, may form a mode and be guided along the gap 125.

Provided may be additional layers 141 and 142 that cover the waveguide thin film 110 and have a refractive index less than that of the waveguide thin film 110. The additional layers 141 and 142 may include silica or polymer. Unlike in FIG. 16, only one of the additional layers 141 and 142 may be disposed to cover one of the upper and lower surfaces of the waveguide thin film 110. Moreover, the additional layers 141 and 142 may be disposed to contact directly or be separated from the waveguide thin film 110.

The additional layers 141 and 142 may be provided for steadily maintaining a mode propagation condition against external perturbation or for convenience in treatment.

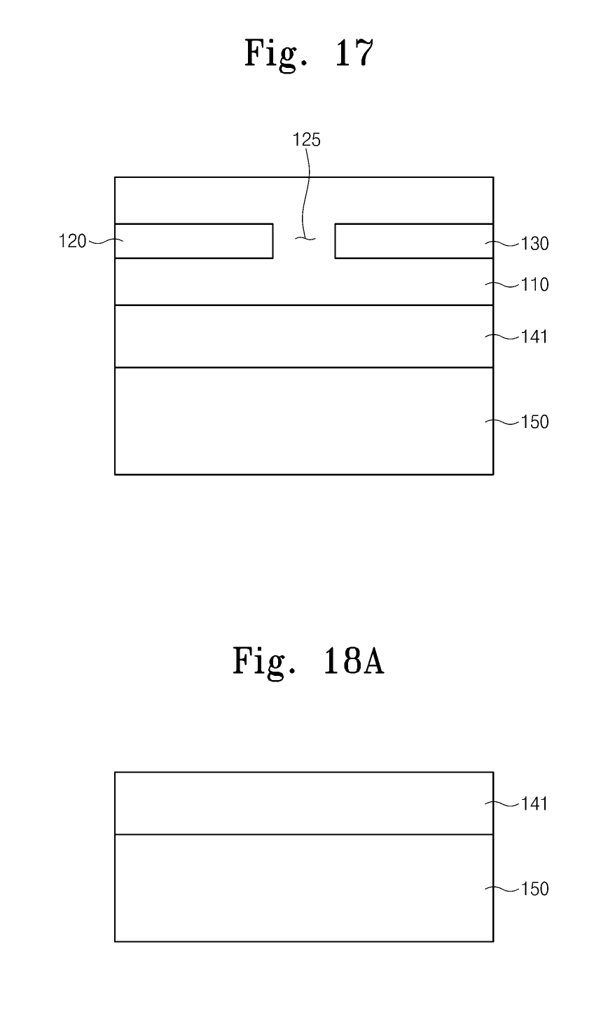

FIG. 17 is a cross-sectional view for describing an optical waveguide according to a ninth embodiment of the present invention. A detailed description will be omitted on the substantially same technical feature as that of an embodiment of the present invention that has been described above with reference to FIG. 1.

Referring to FIG. 17, inductive thin films 120 and 130 are disposed to be separated from each other. Provided is a waveguide thin film 110 that fills a gap 125 for separating the inductive thin films 120 and 130 and covers at least one portion of the inductive thin films 120 and 130. The refractive index of the waveguide thin film 110 is greater than the refractive indexes of the inductive thin films 120 and 130. Light, which is transferred to the waveguide thin film 110 filling the gap 125, may form a mode and be guided along the gap 125.

Provided may be an additional layer 141 that covers the waveguide thin film 110 and has a refractive index less than that of the waveguide thin film 110. The additional layer 141 may include silica or polymer. The additional layer 141 may be disposed to contact directly or be separated from the waveguide thin film 110. The additional layer 141 may be provided for steadily maintaining a mode propagation condition against external perturbation or for convenience in treatment.

Provided may be a basal layer 150 that covers the waveguide thin film 110. The basal layer 150 may be a semiconductor substrate, a printed circuit board or a polyimide substrate. The basal layer 150 may cover the waveguide thin film 110 by disposing the additional layer 141 inbetween.

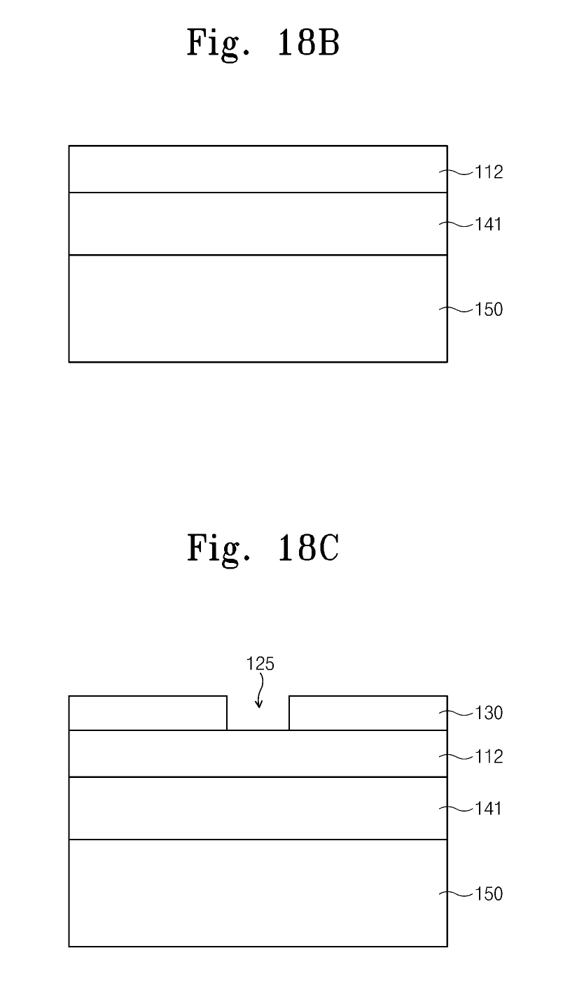

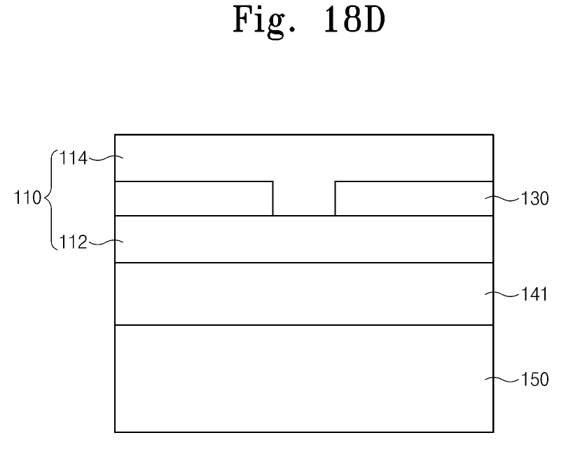

FIGS. 18A to 18D are cross-sectional views for describing a method of forming optical waveguide according to an embodiment of the present invention.

Referring to FIG. 18A, an additional layer 141 is formed on a basal layer 150. The basal layer 150 may be one that supports the optical waveguide in structure. The basal layer 150 may be formed as a semiconductor substrate, a printed circuit board or a polyimide substrate. For example, the feed plate of a roll-to-roll process or basal film may be used. The basal layer 150 enables the optical waveguide to be easily treated, or enables an optical transmission device or/and optical reception device to be easily coupled.

Referring to FIG. 18B, a first waveguide thin film 112 is formed on the additional layer 141. The additional layer 141 may have a refractive index less than that of the first waveguide thin film 112. The additional layer 141 and the first waveguide thin film 112 may be formed in a direct printing process or a roll-to-roll process. Specifically, the additional layer 141 and the first waveguide thin film 112 may be formed in a laminating process, a roll printing process, an inkjet printing process, a screen printing process, a spraying process or a doctor blade process.

Referring to FIG. 18C, inductive thin films 130 are formed on the first waveguide thin film 112. The inductive thin films 130 may have a refractive index less than that of the first waveguide thin film 112. Moreover, the inductive thin films 130 are formed to be separated from each other, and a separated gap 125 between the inductive thin films 130 may be determined depending on the desired characteristic of the optical waveguide.

Referring to FIG. 18D, a second waveguide thin film 114 is formed to fill the separated gap 125 between the inductive thin films 130 and to cover the inductive thin films 130. The second waveguide thin film 114 may be formed of the same material as or a material different from that of the first waveguide thin film 112. The refractive indexes of the first and second waveguide thin films 112 and 114 may be greater than those of the inductive thin films 130. The first and second waveguide thin films 112 and 114 may configure the waveguide thin film 110 of the optical waveguide.

Although the method of forming optical waveguide according to an embodiment of the present invention has been described above with reference to FIGS. 18A to 18D, as described above on embodiments of the present invention, the basal layer 150 and the additional layer 141 are not necessarily required in the configuration of the optical waveguide according to embodiments of the present invention. Accordingly, a case that does not include a process of preparing or forming the basal layer 150 and the additional layer 141 is included in the spirits and scopes of embodiments of the present invention. For example, the first waveguide thin film 112 is prepared in advance, and subsequent processes may be performed using the first waveguide thin film 112 instead of the feed plate of a roll-to-roll process.

The first waveguide thin film 112, the second waveguide thin film 114 and the inductive thin films 130 may be formed in a continuous process. The continuous process may be a direct printing process or a roll-to-roll process. Specifically, the first waveguide thin film 112, the second waveguide thin film 114 and the inductive thin films 130 may be formed in a laminating process, a roll printing process, an inkjet printing process, a screen printing process, a spraying process or a doctor blade process.

According to embodiments of the present invention, a method of forming optical waveguide may be easily performed because of using a continuous process. A formation method using a continuous process can efficiently provide a flexible optical transmission line suitable for implementing optical interconnection between various boards or different equipments.

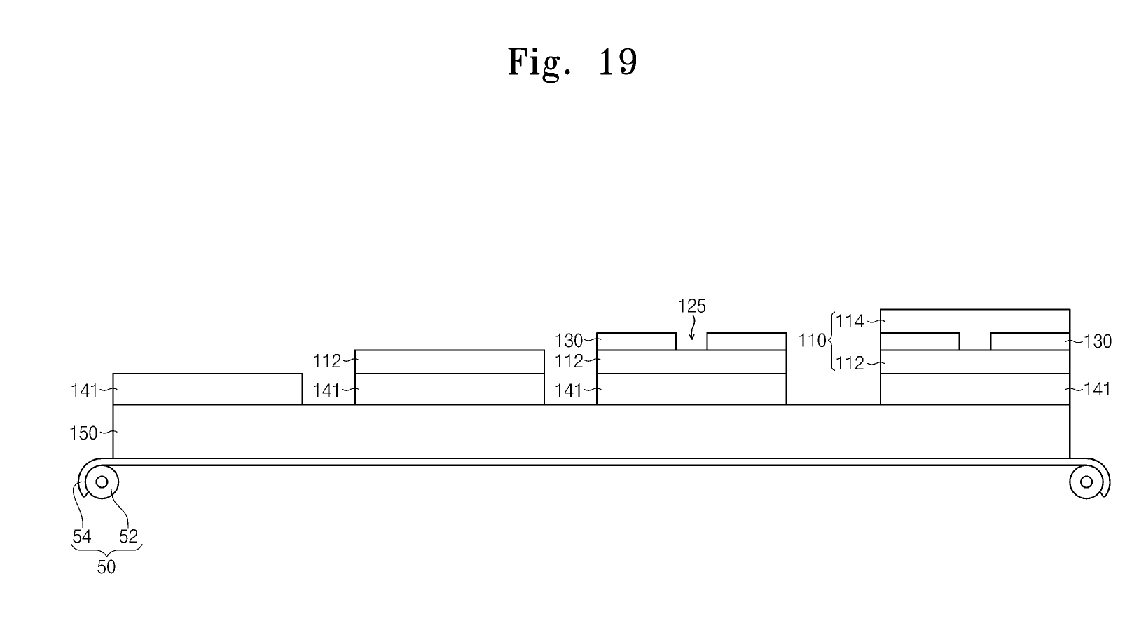

FIG. 19 is cross-sectional views for describing a method of forming optical waveguide based on a continuous process according to an embodiment of the present invention. A waveguide structure in each process stage, representing the flow of a continuous process, is illustrated with respect to the cross-sectional surface of a waveguide instead of a direction as seen from the side of continuous process equipment, for convenience in expression. A detailed description will be omitted on the substantially same repetitive technical feature as that of an embodiment of the present invention that has been described above with reference to FIGS. 18A to 18D.

Referring to FIG. 19, an optical waveguide is formed by a continuous process, for example, a roll-to-roll process. Alternatively, the optical waveguide may be formed in a direct printing process on the same principle as that of FIG. 18. In a method of forming optical waveguide, all processes may be performed in a state where a basal layer 150 is being continuously conveyed. The basal layer 150 may be prepared on a roller device 50 that includes a feed roller 52 and a feed plate 54, or the basal layer 150 itself may replace the feed plate 54. An additional layer 141 is first formed on the basal layer 150. Subsequently, the basal layer 150 is conveyed by the roller device 50 and thereby a first waveguide thin film 112 is formed.

After the first waveguide thin film 112 is formed, the basal layer 150 is conveyed by the roller device 50, and inductive thin films 130 are formed. The inductive thin films 130 are separated from each other and thereby a gap 125 is formed. A second waveguide thin film 114, which fills the gap 125 and covers the inductive thin films 130, is formed. A waveguide thin film 110 may be formed by the first and second waveguide thin films 112 and 114. A continuous process according to an embodiment of the present invention may include a laminating process, a roll printing process, an inkjet printing process, a screen printing process, a spraying process or a doctor blade process.

According to embodiments of the present invention, the optical waveguide transmits an optical signal along the waveguide thin film that fills the gap for separating the inductive thin films. The waveguide thin film can have various shapes, and can transfer or couple/separate various lightwave components. The optical waveguide according to embodiments of the present invention can be easily formed through a continuous process.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An optical waveguide, comprising:
inductive thin films disposed to be separated from each other; and
a waveguide thin film filling a gap which separates the inductive thin films, and covering at least one portion of the inductive thin films,
wherein a refractive index of the waveguide thin film is greater than refractive indexes of the inductive thin films.

2. The optical waveguide of claim 1, wherein the waveguide thin film covers upper and/or lower surfaces of the inductive thin films.

3. The optical waveguide of claim 1, wherein light, which is transferred to the waveguide thin film filling the gap, forms a mode and is guided along the gap.

4. The optical waveguide of claim 1, wherein a width of the gap is equal to or greater than one-fifth of a thickness of the waveguide thin film.

5. The optical waveguide of claim 1, wherein the inductive thin films comprises:
first inductive thin films covered by the waveguide thin film; and
second inductive thin films covering a side of the waveguide thin film,
wherein the second inductive thin films are thicker than the first inductive thin films.

6. The optical waveguide of claim 1, wherein:
the inductive thin films comprises first, second and third inductive thin films disposed on the same plane, and
the gap comprises:
a first gap separating the first and second inductive thin films; and
a second gap separating the second and third inductive thin films.

7. The optical waveguide of claim 6, wherein a first lightwave component which is transferred along the first gap of the waveguide thin film and a second lightwave component which is transferred along the second gap are combined to form one optical mode and are guided.

8. The optical waveguide of claim 6, wherein a first lightwave component which is transferred along the first gap of the waveguide thin film and a second lightwave component which is transferred along the second gap are separated from each other to form respective optical modes.

9. The optical waveguide of claim 6, further comprising:
a first region comprising the first and third inductive thin films; and
a second region comprising the first, second and third inductive thin films, wherein:
the gap further comprises a third gap separating the first and third inductive thin films in the first region, and
the first and second gaps are disposed in the second region, and are formed to be split from the third gap.

10. The optical waveguide of claim 9, wherein the third gap, the first gap and the second gap have a Y-shaped connection structure therebetween.

11. The optical waveguide of claim 6, comprising: first and second regions comprising the first, second and third inductive thin films respectively,
wherein:
a separated distance between the first and second gaps disposed in the first region is shorter than a separated distance between the first and second gaps disposed in the second region.

12. The optical waveguide of claim 11, wherein:
respective lightwave components, which are transferred along the first and second gaps, are combined to form one optical mode and are guided in the first region, and
the lightwave components are divided into respective optical modes and are guided in the second region.

13. The optical waveguide of claim 1, wherein the inductive thin films comprise:
first inductive thin films disposed on a first plane; and
second inductive thin films disposed on a second plane above the first plane.

14. The optical waveguide of claim 13, wherein the gap comprises:
a first gap separating the first inductive thin films; and
a second gap separating the second inductive thin films,
wherein the first and second gaps are disposed to be overlapped with each other.

15. The optical waveguide of claim 13, wherein:
the gap comprises:
a first gap separating the first inductive thin films; and
a second gap separating the second inductive thin films, and
the optical waveguide comprises:
a first region where the first and second gaps are disposed to be overlapped with each other; and
a second region where the first and second gaps are disposed to be separated from each other.

16. The optical waveguide of claim 1, further comprising: an additional layer covering the waveguide thin film, and having a refractive index less than that of the waveguide thin film.

17. The optical waveguide of claim 1, further comprising: a basal layer covering the waveguide thin film.

18. A method of forming optical waveguide, the method comprising:
forming a first waveguide thin film;
forming inductive thin films which are separated from each other on the first waveguide thin film; and
forming a second waveguide thin film which fills a gap separating the inductive thin films and covers the inductive thin films.

19. The method of claim 18, wherein the first waveguide thin film, the inductive thin films and the second waveguide thin film are formed in a continuous process.

20. The method of claim 19, wherein the continuous process comprises a roll-to-roll process or a direct printing process.
